(19) United States
(12) Patent Application Publication
(10) Pub. No.: US 2007/0237683 A1
(43) Pub. Date: Oct. 11, 2007

(54) Microwell assembly having replaceable well inserts with reduced optical cross-talk

(75) Inventors: Winston Z. Ho, Hacienda Heights, CA (US); Yu-Tsung Chou, Taipei (TW)

Correspondence Address: LIU & LIU, 444 S. FLOWER STREET SUITE 1750, LOS ANGELES, CA, 90071, US

(73) Assignee: Maxwell Sensors, Inc.

(21) Appl. No.: 11/393,587

(22) Filed: Mar. 30, 2006

(51) Int. Cl. B01L 3/00

(52) U.S. Cl. 422/102

(57) ABSTRACT

A microwell assembly that includes a tray that supports well inserts. The tray has an array of cylindrical cavities, each having an optically opaque cylindrical wall and an open base. The well inserts have wells having an optically clear bottom (e.g., a flat bottom, or a bottom of another geometry). The cylindrical cavities are sized to receive the well inserts such that the bottom of the wells does not extend beyond the cylindrical walls of the cavities. The opaque walls of the tray optically isolates the wells. In one embodiment, the entire structure of the well insert is economically made of the same material such as clear polymer. The tray may be reusable, and the well inserts are disposable. In one embodiment, the well insert may be configured in the form of a multi-well strip that includes wells at a spacing conforming to the inter-well spacing of a standard microplate.

### BACKGROUND OF THE INVENTION

All publications referenced herein are fully incorporated by reference, as if fully set forth herein.

1. Field of the Invention

The invention is generally related to microplates, and particularly to a microwell assembly having replaceable well inserts, and more particularly a microwell assembly having replaceable wells which is structured to reduce optical cross-talk between wells.

2. Description of Related Art

Assays of biochemical systems are carried out on a large scale in both industry and academia. Apparatus for high throughput sample assays (e.g., immunological and nucleic acid testing) is commercially available and in wide spread use. One familiar component of such apparatus is a microplate, which comprises a substrate or base plate supporting an array of wells. Because they are relatively easy to handle and low in cost, microplates are often used for disease diagnostics and drug discoveries. For example, in the drug industry, the microplate is an essential tool used in drug screening; it allows a large number of sample compounds to be assayed simultaneously, rapidly and efficiently. Each microplate comprises a number of wells, each containing a tiny amount of a compound to be tested, and a test reagent. By studying the effect resulting from interactions of the compound and the reagent, it is possible to determine the potential value and effectiveness of a compound against a particular target biological system or disease.

Prior art microplates typically comprise a plurality of individual wells formed of polymeric materials. Each well has a cylindrical sidewall extending above a substantially planar substrate and base plate defining a bottom, so that an aliquot of a sample may be placed and contained within each well. The wells may be arranged in relatively close proximity in a rectangular array or matrix, allowing samples to be studied individually, or as a group, or in some related fashion. Common sizes for microplates include 8×12 matrix (96 wells), and 16×24 (384 wells), although larger microplates are also used that may include matrices of hundreds or even thousands of wells.

The substrate in the prior art microplates form the plate body and define the well structure. The substrate and bottom is either clear or opaque. The microplate with opaque bottom is used in optical reflection mode and the one with clear bottom is generally used for transmission measurement. Microplates with clear bottom and opaque (e.g., white or black) substrate are widely used for analyzing chemiluminescence, bioluminescence, fluorescence, and absorption reactions. For example, luminescence reactions, including light-emitting chemical reactions (chemiluminescence, “CL”), light-emitting biological reactions (bioluminescence, “BL”), and electro-induced luminescence, have a diverse range of analytical and biological applications. Advantages of luminescence assays include very high sensitivity due to the current technology in photon counting and enzyme amplification, and assays do not need an external excitation light source. The detection limit of the “CL” or “BL” method has achieved atto-moles sensitivity, which means even a few luminescence photons can be detected by the highly sensitive photon counting photon-multiplier tube. The luminescence signals are typically detected from the bottom of the microwell in very close proximity, because the photons generated by the chemical reaction are non-coherent and divergent. Unfortunately, when a bottom of the microplate is an optically clear plate, even it is a thin plate; the non-coherent, randomized photons in a well can propagate to the adjacent microwells through the material of the bottom plate. Although the typical cross-talk is on the order of 10⁻⁴, it still means 1,000 photons will leak to the neighboring wells for every 10⁷ photons generated in a microwell. Optical cross-talk becomes a very serious issue for detecting low quantity of analyte, which typically involves generating on the order of 100-100,000 photons.

For example, in reference to FIG. 1 and FIG. 2, a conventional microplate 100 includes a substrate 105 having a plurality of wells 102. Each well 102 has a generally cylindrical sidewall 104 extending above a separate piece of substantially planar base plate 106 defining a bottom 108 of the wells 102. The substrate 105 is made of an opaque plastic and the base plate 106 is made of clear plastic, and they are bonded together. Ultrasound bonding or thermal bonding has been used for this purpose. The problem with this conventional plates is that the clear base plate 106, even with a typical thickness of 0.1-1.0 mm, still leaks photons from one well to the surrounding wells.

Some have attempted to reduce optical crosstalk in microplates, as exemplified in the following patents:

U.S. Pat. No. 6,503,456 to Knebel et al. discloses a microplate having at least one frame part and at least one base part assigned to the frame part, the at least one frame part having at least 384 cells, the at least one base part being formed as a membrane or film, the base part forming the bases of the cells, the bases of the cells being formed as a membrane or film and having a thickness of at most 500 μm.

U.S. Pat. No. 6,051,191 to Ireland et al. discloses a microplate affording an array of discrete, separate sample wells in which each sample well comprises a well of a first polymer composition, the well having side walls and a base, and being located in a matrix of a second polymer composition, the side walls each having first and second oppositely disposed ends, said matrix shrouding the side walls of each said well and extending beyond both the first and second ends of the side walls of each said well, said matrix leaving at least a portion of the base unshrouded, the second polymer composition being opaque, each well being thermally bonded to the matrix of the second polymer composition, so as to form an integral structure.

U.S. Pat. No. 5,759,494 to Szlosek et al. discloses a microplate to reduce optical cross-talk during the assaying of samples. The method includes steps of inserting a plate of light permeable material into a mold cavity that includes sections shaped to form the sidewalls of the plurality of wells, injecting molten light impermeable material into the mold cavity, and cooling the light impermeable material to form the microplate with the light impermeable material forming the sidewalls of each of the plurality of wells and the plate of light permeable material forming the bottom wall of each of the plurality of wells.

All the above noted patents all disclose relatively complicated monolithic structures and associated fabrication methods, in an attempt to reduce optical cross-talk in microplates. It would not be practical to make and use the patented microplate structures.

Heretofore, microplates are preferably made using a single material by injection mold, so low production cost can be maintained. Common microplate materials are polymers, such as polystyrene, polycarbonate, polyvinylchloride (PVC), polypropylene, or the like, chosen for their optical properties. For microplates having clear bottom and opaque walls, it becomes necessary to use two pieces of materials, such as a white or black substrate for the frame and a clear bottom plate as the optical window. For this type of microplate, it is necessary to bond two pieces of materials together. However, the bonding process decreases the production rate and significantly increases the manufacturing cost by as much as 4 to 10 times the manufacturing cost for a single material microplate. The cost difference becomes more significant when a large quantity of plates is being used in a series of studies typical undertaken during research, such as drug discoveries.

Another factor that increases costs is that microplates are disposable consumable items. A microplate is commonly used only once and it is then disposed of. Heretofore, all of the bottom clear luminescence plates have 96 (8×12) wells or 384 (16×24) wells. Since the plates have the fixed capacity for running 96 or 384 tests simultaneously, it becomes less economical when just a few tests are needed.

In response to this problem, commercial vendors produced 8-well microstrips. The 8-well microstrips are made of a single material, so they can be manufactured relatively cheaply. However, the 8-well microstrips are either entirely clear or entirely opaque. They are not suitable for luminescence; that is the clear microstrips are faced with the problem of optical cross-talk, and the opaque microstrips cannot be used for bottom optical reading. Consequently, current 8-well microstrips are used for optical detection either in reflection mode or using a collimated optical beam for absorbance measurement.

Evergreen Scientific and other companies market 8-well strips that feature raised rims on each well to minimize cross-contamination. The wells can have a flat-bottom, round “U” bottom, conical “V” bottom, open-bottom format for membrane attachment, and “C” bottom which has a small chamfered/radiused corner with a large flat bottom. The strips are held in a holder or rack (e.g., having square holes) for packaging and shipping. The rack or holder is not designed to provide any structure that avoids optical cross-talk between wells. For example, the strips of wells are merely inserted in the perforated top surface of the holder or rack, which has a hollow understructure. The combination of the frame and strip is not suitable for chemiluminescence detection applications.

It is therefore desirable to have a microplate structure that allows assays to be conducted with reduced optical cross-talk, in a convenient and inexpensive manner, which would overcome the drawbacks of the prior art microplates.

### SUMMARY OF THE INVENTION

The present invention is directed to a novel microwell assembly structure that reduces optical cross-talk between wells, by providing a tray that supports well inserts, wherein the tray has optically opaque walls to optically isolate the wells of the inserts.

In one aspect of the present invention, the tray has an array of cylindrical cavities, each having an optically opaque cylindrical wall and an open base. The well inserts have wells having an optically clear bottom (e.g., a flat bottom, or a bottom of another geometry). The cylindrical cavities are sized to receive the well inserts such that the bottom of the wells does not extend beyond the cylindrical walls of the cavities. In one embodiment, the entire structure of the well insert is economically made of the same material, e.g., a clear polymer.

The tray may be configured with cavities in an 8×12 array or a 16×24 array, which may have a footprint that conform to the overall dimensional standards for microplates practiced in the art. The tray may be reusable, and the well inserts are disposable. A user can assemble the number of inserts into the tray as needed, resulting in significant savings especially when a large number of tests are needed. The microwell assembly may be applied to various laboratory devices (e.g., a robotic system) for undertaking experimentations and assays.

In one embodiment, the well insert may be configured in the form of a multi-well strip that includes wells at a spacing conforming to the inter-well spacing of a standard microplate.

### BRIEF DESCRIPTION OF THE DRAWINGS

For a fuller understanding of the scope and nature of the invention, as well as the preferred mode of use, reference should be made to the following detailed description read in conjunction with the accompanying drawings. In the following drawings, like reference numerals designate like or similar parts throughout the drawings.

FIG. 1 is a perspective view of a conventional clear bottom microplate.

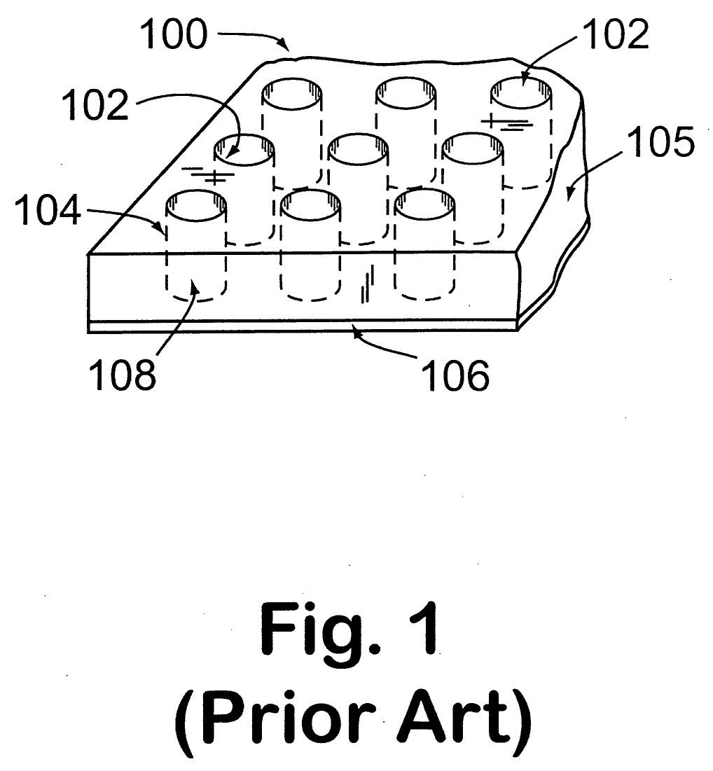

FIG. 2 is a top view of the conventional clear bottom microplate.

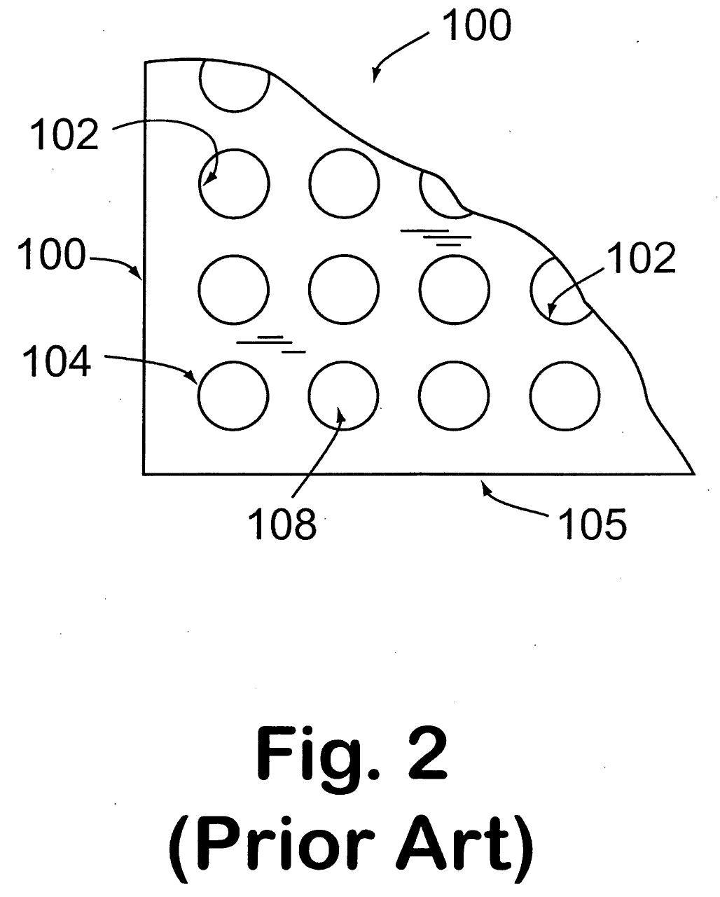

FIG. 3 is a perspective view of a tray for holding multi-well strips in accordance with one embodiment of the present invention.

FIG. 4 is a perspective view of a well insert in accordance with one embodiment of the present invention.

FIG. 5A is a perspective view illustrating assembly of the well insert to the tray; FIG. 5B is a perspective view of the multi-well assembly structure.

FIG. 6 is a sectional view taken alone line 6-6 in FIG. 5B.

### DETAILED DESCRIPTION OF EXEMPLARY EMBODIMENTS

The present description is of the best presently contemplated mode of carrying out the invention. This description is made for the purpose of illustrating the general principles of the invention and should not be taken in a limiting sense. The scope of the invention is best determined by reference to the appended claims.

For purposes of illustrating the principles of the present invention and not by limitation, the present invention is described herein below by reference to a rectangular microwell assembly structure having a footprint and inter-well spacing that conforms to a standard microplate and a well insert that is configured in a multi-well strip. The standard footprint of a microplate, for example, has a length of about 5.03 inch (127.76 mm) and width of about 3.365 inch (85.47 mm). The plate height is about 0.565 inch. The diameter of the round well is about 0.276 inches (7.00 mm) for 96 wells and about 0.138 inches (3.50 mm) for 384 wells. The well-to-well center spacing in both orthogonal directions of the array of wells, is about 0.354 inches for 96 well and about 0.177 inches for 384 wells. However, it is understood that the present invention is equally applicable to microwell assemblies of other overall geometries, which may be configured to include any number of well inserts having any number of wells of any spacing, without departing from the scope and spirit of the present invention.

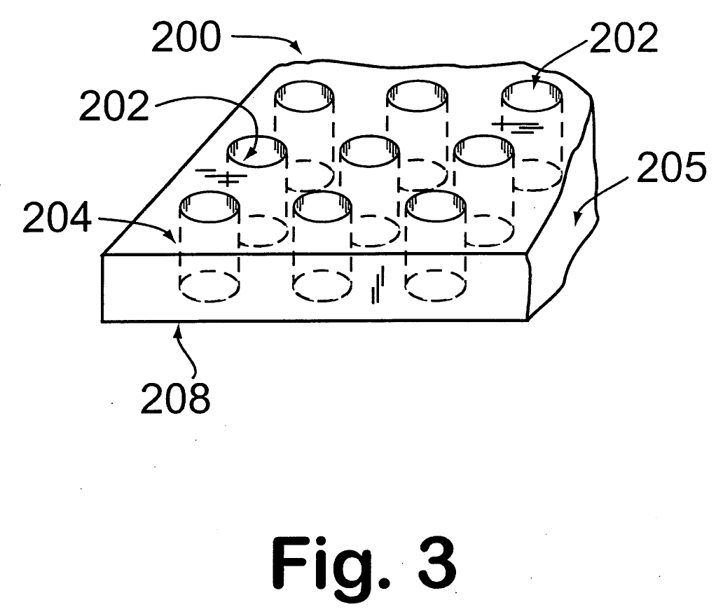

In accordance with one embodiment of the present invention illustrated in FIG. 3, a strip holding tray 200 is configured from a substrate or plate 205 (e.g., of about 7.5 cm by 12.5 cm planar area, and about 1.25 cm thick. In this particular embodiment, the plate 205 is generally planar, having a uniform thickness, which is provided with ninety-six cylindrical vertical through-holes 202 in a 8×12 array. Each hole 202 has an axis that is orthogonal to the plane of the plate. The hole 202 is defined by a generally cylindrical sidewall 204 (e.g., the hole have a cross-section that is circular, or other geometries) that is optically opaque. The tray may be made of an opaque polymeric material such as white or black colored polyeurathene, polycarbonate, polyvinyl, polystyrene, polyvinylchloride (PVC), polypropylene, acrylic, or a glass or quartz material, or a metallic material such as aluminum. For reduced cost of manufacturing, polymeric materials are preferred for their ease of injection molding. Alternatively, the sidewall of the holes 202 may be coated with an optically opaque material.

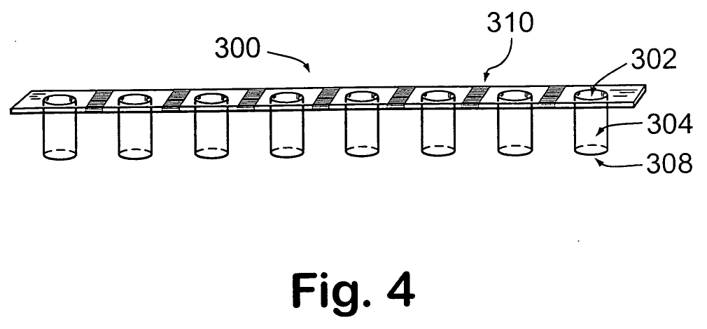

A complementary well insert may be in the form of a multi-well strip 300 that is configured as illustrated in FIG. 4. The multi-well strip 300 includes a body comprising a plurality of wells 302 defined by cylindrical walls 304 that are connected by a thin ribbon 310 (e.g., 1 mm thick and 7.5 mm wide for an 8-well strip), to form an overall multi-well strip structure. The wells 302 each has a transparent bottom 308. To reduce cost of manufacturing, the multi-well strip 300 can be made from the same transparent material throughout. For example, the wells 302 (including the cylindrical walls 304 and the bottom 308) and the ribbon 310 are injection molded from an optically clear polymeric material (such as polyeurathene, polycarbonate, polyvinyl, polystyrene, polyvinylchloride (PVC), polypropylene, acrylic), or a glass or quartz material. Alternatively, though more expensively, the multi-well strip may be made from a glass material, a quartz material, or other transparent materials. In this particular embodiment, the multi-well strip 300 has 8 wells.

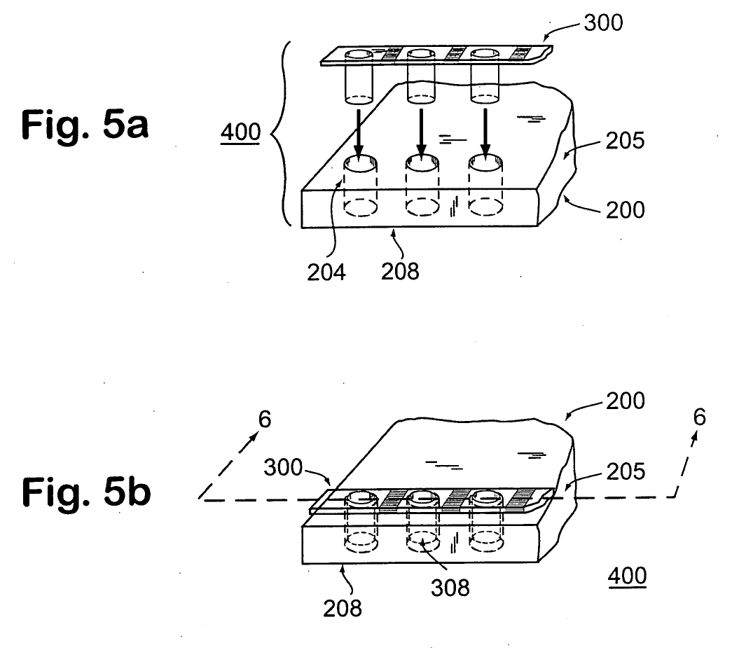

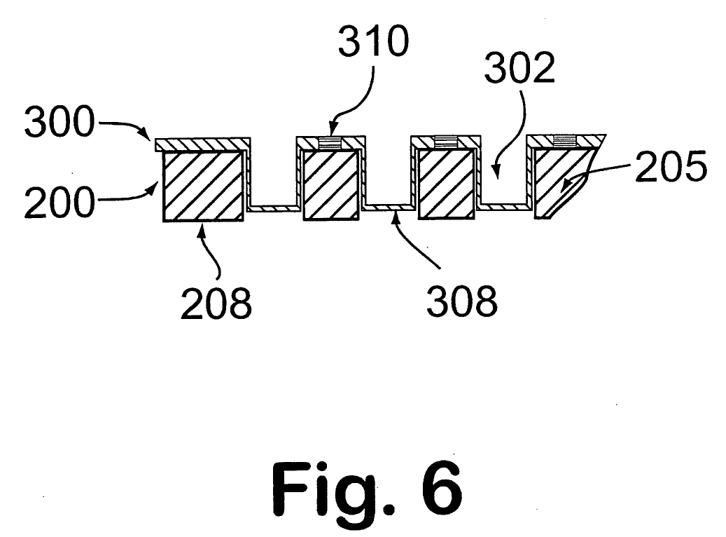

The configuration, spacing, exterior size and shape of the wells 302 of the multi-well strip 300, and the configuration, spacing, thickness and shape of the holes 202 in the plate 205 of the tray 200, should be chosen so that the wells 302 can fit inside the holes 202 in the plate 205 of the tray 200. The diameter of the cylindrical holes 204 is slightly larger than the exterior diameter of the wells 304, so the wells 304 can be received in the holes 204 with a slight clearance (e.g., 0.1 mm), with the ribbon 310 of the multi-well strip 300 supported by the upper surface of the plate 205 of the tray 200. FIG. 5A illustrates the insertion of the multi-well strip 300 into the plate 205 of the tray 200. FIG. 5B illustrates the multi-well strip 300 being supported by the tray 200. Further, the length of the cylindrical walls 304 of the multi-well strip 300 and the thickness of the plate 205 of the tray 200 are chosen such that the bottom 308 of each well 302 does not protrude from the bottom surface of the plate 205 of the tray 200 (i.e., the bottom 308 is recessed from the bottom 208 of the cylindrical walls 204 in the plate 205, by 0.1 mm or more, for example). Therefore, the wells in the multi-well strip 300 are completely surrounded by the opaque walls 204 of the plate 205, with the exception of the thin region at the opening of the wells 302 that are connected by the ribbon 310. FIG. 6 is a sectional view of the multi-well strip 300 as supported and the tray 200.

The combination of the multi-well strip 300 and the tray 200 completes a microwell assembly 400, as illustrated. The microwell assembly 400 provides wells that have optically clear bottom window 308, which are optically isolated by the optically opaque walls 204 of the plate 205 of the tray 200. By recessing the bottom 308 of the wells 302 from the bottom of the opaque cylindrical walls 204 of the tray 200, optical cross-talk between wells can be significantly reduced. There would be essentially no photons leaking between the bottoms 308 of the wells. The only connection between the wells 302 is in the ribbon 310. However, the ribbon 310 being at the top opening of the wells 302, the effect of any leakage of photons through the ribbon 310 is relatively small, as the optical reading is taken near the bottom of the wells 302. To further reduce the optical cross-talk from well to well via the ribbon, a light blocking barrier structure (e.g., a channel notch) can be provided across the ribbon between wells, or an optically opaque color (e.g., black) or material may be included in the ribbon (schematically shown as the shaded region in FIG. 4). The ribbon 310 is shown to be of uniform width in the illustrated embodiment. However, it is well within the scope of the present invention to use a ribbon with narrowing width in between the wells. The ribbon 310 may be rigid, or flexible.

While FIG. 5 and 6 illustrate the assembly of a single multi-well strip 300 to the tray 200, a plurality of multi-well strips 300 may be supported by the tray 200. In the illustrated embodiment of the tray 200, up to twelve multi-well strips 300 may be supported by the tray 200. Trays of same or different sizes may be configured to support additional multi-well strips having same or different number of wells, or wells of smaller or larger sizes. Further, multi-well strips having lesser (e.g., 4 wells, or even a single-well insert) or larger number of wells (e.g., 12 wells) may be supported by the tray 200.

During use, a user can assembly any number of wells or any number of multi-well strips into the strip holding tray 200, according to the need of the experiment or the number of tests. After the experiment, the strip holding tray 200 can be reused. The only consumable item is the inexpensive multi-well strips.

From the foregoing, it should now be appreciated that a clear bottom microplate for chemiluminescence assays can be effectively and efficiently assembled by inserting an optically clear well inserts, such as a multi-well strip, into an optically opaque strip holding tray, wherein the holding tray prevents optical cross-talk, overcoming the drawbacks of the prior art microplate structures. Although the foregoing discussion is illustrated for detecting luminescence signal, the present invention is generally applicable for monitoring optical signal from other instruments, such as spectrometers, sensors, and other medical and non-medical devices.

While the invention has been described with respect to the described embodiments in accordance therewith, it will be apparent to those skilled in the art that various modifications and improvements may be made without departing from the scope and spirit of the invention. For example, the optical clear bottom of the wells in the inserts may have different configurations, such as flat bottom, V-shaped bottom, U-shaped bottom, chamfered bottom, etc. Further, the tray may have a plate of non-uniform thickness, such as a plate with an array of holes each defined by a cylindrical wall extending beyond the bottom of the wells in the well insert, but otherwise has a hollow underbody. This hollow underbody structure is desirable when the tray has a thick plate structure to accommodate deep wells. In addition or in the alternate, the top surface of the plate may be provided with a hollow structure except at the cylindrical holes. Still further, not all the holes in the tray may be of the same size in the same tray. Some holes may be configured smaller or larger to accommodate complementary wells of smaller or larger sizes. A complementary well insert may include wells of different sizes. Accordingly, it is to be understood that the invention is not to be limited by the specific illustrated embodiments, but only by the scope of the appended claims.

I claim:

1. A microwell assembly, comprising:
a tray, comprising a plate having a planar array of holes each defined by a cylindrical wall that is optically opaque; and
a well insert supported by the tray, the well insert comprising a body defining at least one cylindrical well that has a bottom that is optically clear,
wherein each hole is sized and shaped to receive the well, with the cylindrical wall of the hole extending beyond the bottom of the well when the well insert is supported by the tray, thereby reducing optical cross-talk between well bottom.

2. The microwell assembly as in claim 1, wherein the well has a cylindrical wall that is optically clear.

3. The microwell assembly as in claim 2, wherein the body of the well insert is made entirely of an optically clear material.

4. The microwell assembly as in claim 1, wherein the body of the well insert is made of at least one of polyeurathene, polycarbonate, polyvinyl, polystyrene, polyvinylchloride (PVC), polypropylene, and acrylic.

5. The microwell assembly as in claim 4, wherein the body of the well insert defines at least one of 1, 8 and 12 wells.

6. The microwell assembly as in claim 5, wherein each well has an interior diameter of 2 to 10 mm.

7. The microwell assembly as in claim 1, wherein the body of the well insert defines a plurality of wells, and the tray is structured to receive the plurality of wells.

8. The microwell assembly as in claim 7, wherein the body of the well insert comprises a ribbon that connects the plurality of wells at their openings.

9. The microwell assembly as in claim 8, wherein the body of the well insert is made entirely of an optically clear material.

10. The microwell assembly as in claim 9, wherein the ribbon includes at least one of a light blocking barrier structure and a optically opaque color or material between adjacent wells.

11. The microwell assembly as in claim 1, wherein the plate is of uniform thickness.

12. The microwell assembly as in claim 11, wherein the plate is made entirely of an optically opaque material.

13. The microwell assembly as in claim 12, wherein the plate is made of an opaque white or black polymer.

14. The microwell assembly as in claim 1, wherein the plate has an overall shape and dimension generally conforming to a standard microplate.

15. The microwell assembly as in claim 14, wherein the standard microplate comprises at least one of a 96-well microplate having a 8×12 array of wells and a 384-well microplate having a 16×24 array of wells.

16. The microwell assembly as in claim 1, wherein the cylindrical wall of the hole extends at least 0.1 mm beyond the bottom of the well when the well insert is supported by the tray.

17. A method of analysis of a sample, comprising:
providing a microwell assembly as in claim 1;
conducting assaying of the sample; and
analyzing the sample via the clear bottom of the wells.

18. The method as in claim 17, wherein the sample is analyzed using at least one of chemiluminescence, bioluminescence, electroluminescence, and fluorescence analysis.
